(19) United States
(12) Patent Application Publication
(10) Pub. No.: US 2005/0159137 A1
(43) Pub. Date: Jul. 21, 2005

(54) Cell phone directory

(76) Inventors: Luis Carlos Ramirez, Albuquerque, NM (US); Mariza Ramirez, Albuquerque, NM (US)

Correspondence Address: Luis C. Ramirez, 1212 Westerfeld Dr. NE, Albuquerque, NM, 87112, US

(21) Appl. No.: 10/366,675

(22) Filed: Nov. 17, 2003

(51) Int. Cl. H04M 3/42

(52) U.S. Cl. 455/414.1; 379/218.01

(57) ABSTRACT

This is the method of enabling the customer to access residential, business or government directory information on a city, state or federal level from a cell phone. The customer will select the directory option from the main menu listing. Then the customer will select one of the following submenus: local or national. The next step will be for the customer to select one of the following: residential, business or government. The customer will then have the option to enter one of the following: last name, business name, business category, or the first letter the specific option the customer is searching for. This will provide the customer with an alphabetical list under the entered request. When available the address will also be provided. Auto dial and save functions will be available. In order to do this the customer will need to spell out their request by press the number 2 for the letter A, B or C; number 3 for the letters D, E or F etc. A yearly download will be required to have an up to date listing.

The customer must select from the main directory menu select the local option then from the local submenus select one of the following: residential, business or government.

Residential: The method of searching by entering first one, two or three letters of the last name or the full last name. The customer may then scroll through the alphabetical listing and select the desired full name. Once the desired listing is found the send button may be pressed to automatically dial the selected number.

Business: The method of searching by entering first one, two or three letters of the business name, Full business name or the type of business. The customer may then scroll through the alphabetical listing and select the desired business. Once the desired listing is found the send button may be pressed to automatically dial the selected number.

Government: The method of searching from the submenu by city or county department listings in alphabetical order. Select from the city or county submenu the desired option by scrolling through the alphabetical listings of departments or offices. Once the desired listing is found the send button may be pressed to automatically dial the selected number.

### National Directory

The national directory will enable the customer to search for a residential, business, or government listings at a city/state/county or federal level. The customer must have long distance access on their phone in order to access this information. This option can be accessed primarily by the area code. If area code is unknown the listing can be searched by state or city. If area code has multiple cities then a specific city may be selected.

Residential: The method of searching of a residential listing is by selecting directory from the main menu then selecting the national directory menu. From the National directory menu select the residential submenu. The customer must then enter the area code desired. This will provide the customer with all the cities pertaining to that area code in alphabetical order. The customer can then select the city desired. Next the residential search can be done by entering first one, two or three letters of the last name or the full last name. The customer may scroll through the alphabetical listing and select the desired full name. Once the desired listing is found the send button may be pressed to automatically dial the selected number.

Business: The method of searching of a business listing is by selecting directory from the main menu then selecting the national directory menu. From the National directory menu enter the area code desired. This will provide the customer with all the cities pertaining to that area code in alphabetical order. The customer can then select the city desired. Next the business search can be done by selecting from the business submenu business type or business name. Customer may then enter the first one, two or three letters of the business name or the full business name or type of business. The customer may scroll through the alphabetical listing and select the desired business. Once the desired listing is found the send button may be pressed to automatically dial the selected number.

Government: The method of searching of a government listing is by selecting directory from the main menu then selecting the national directory menu. From the National directory menu enter the area code desired. This will provide the customer with all the cities pertaining to that area code in alphabetical order. The customer can then select the city desired. The method of searching from the submenu by city or county department listings in alphabetical order. Select from the city or county submenu the desired option by scrolling through the alphabetical listings of departments or offices. Once the desired listing is found the send button may be pressed to automatically dial the selected number.

1. We Luis C. and Mariza Ramirez claim as our invention the Cell Phone Directory which is the method of accessing local, state or National directory information via a cell phone:
